(19) United States
(12) Patent Application Publication
(10) Pub. No.: US 2009/0177580 A1
(43) Pub. Date: Jul. 9, 2009

(54) COLLECTION OF ELECTRIC VEHICLE POWER CONSUMPTION TAX

(76) Inventors: Richard W. Lowenthal, Cupertino, CA (US); Dave Baxter, Monte Sereno, CA (US); Harjinder Bhade, San Jose, CA (US); Praveen Mandal, Los Altos Hills, CA (US)

Correspondence Address: PILLSBURY WINTHROP SHAW PITTMAN LLP, P.O. BOX 10500, MCLEAN, VA, 22102, US

(21) Appl. No.: 12/335,274

(22) Filed: Dec. 15, 2008

Related U.S. Application Data
(60) Provisional application No. 61/081,333, filed on Jul. 16, 2008.
(60) Provisional application No. 61/019,474, filed on Jan. 7, 2008.

(51) Int. Cl. G06Q 20/00

(52) U.S. Cl. 705/39

(57) ABSTRACT

A method of collecting electric vehicle power consumption tax for charge transferred between a local power source and an electric vehicle comprises: providing a network-controlled charge transfer device, charge transfer being controlled by a controller, the controller being connected to a network for communication to a server; requesting by an operator of the electric vehicle to the controller for charge transfer; relaying the request from the controller to the server; determining by the server, from geographical tax rate data and the geographical location of the network-controlled charge transfer device, an applicable tax rate on the charge transfer; enabling charge transfer by communicating from the server to the controller to activate the control device; monitoring the charge transfer using a current measuring device, the controller being configured to monitor the output from the current measuring device and to maintain a running total of charge transferred; detecting completion of the charge transfer; and on detecting completion, processing payment with said payment source, which may include deducting the cost of charge transfer from a subscriber account containing pre-transferred funds, and disabling charge transfer; wherein the request for payment includes the electric vehicle power consumption tax.

### CROSS-REFERENCE TO RELATED APPLICATIONS

This application claims the benefit of U.S. Provisional Application Ser. No. 61/081,333, filed Jul. 16, 2008 and U.S. Provisional Application Ser. No. 61/019,474, filed Jan. 7, 2008, which are expressly incorporated by reference herein.

### BACKGROUND OF THE INVENTION

1. Field of the Invention

This invention relates to the field of systems and methods for collecting an electricity consumption tax for electric vehicles.

2. Description of the Related Art

The electric car, electric vehicle (EV) and battery electric vehicle are all used to describe automobiles powered by one or more electric motors utilizing energy stored in rechargeable batteries. The batteries are recharged by connecting to an electrical outlet. Efficient recharging of the batteries typically requires hours and is often done overnight or while the electric vehicle is parked for a significant time. The use of electric vehicles is limited by the sparse availability of recharging facilities. There is a need for more widespread recharging facilities. Furthermore, there is a need for more recharging facilities available where vehicles are parked for longer periods of time.

An important part of any consumer experience is the ease of acquiring a product—to recharge an electric vehicle this entails finding an available recharging facility, controlling the facility, and paying for the electricity consumed. There is a need for a communication network which facilitates finding the recharging facility, controlling the facility, and paying for the electricity consumed.

Electricity grids have periods of high demand from customers where the demand may approach or even exceed the electricity supply. Conversely, there are periods of low demand which coincide with high electricity production. Demand Response is a mechanism for reducing consumption of electricity during periods of high demand. For example, consumer services such as air conditioning and lighting may be reduced during periods of high demand according to a preplanned load prioritization scheme. Demand Response may also be used to increase demand at times of high electricity production. For example, the cost of electricity may be reduced during periods of low demand. Furthermore, some Demand Response systems encourage energy storage during periods of low demand, for release back into the electricity grid during periods of high demand. For example, battery electric vehicles may be charged during periods of low power demand and then release power back to the grid during periods of high demand.

Electric vehicles can be recharged from a local electricity grid. These vehicles can also be a source of electric power to be transferred to the local electricity grid. The transfer of electricity stored in electric vehicles to the local electric grid is referred to as vehicle-to-grid (V2G). V2G is particularly attractive for electric vehicles which have their own charging devices, such as battery electric vehicles with regenerative braking and plug-in hybrid vehicles. V2G is desirable for peak load leveling—helping to meet the demand for electricity when demand is at its highest. V2G is not widely available—it is principally being used in small pilot schemes. There is a need for more widely available Demand Response and V2G to assist with peak load leveling.

For Demand Response and V2G to be implemented effectively, real time communication of a need for power input into the local electricity grid is required. This communication from electric utility companies needs to reach recharging facility managers and electric vehicle owners and users. There is a need for an efficient communication network for managing peak load leveling using Demand Response and V2G.

Currently, a major source of revenue for building and maintaining highways for vehicular traffic is the gasoline tax. Should electric vehicles start to replace significant numbers of gasoline burning vehicles there will be a drop in tax revenues. To compensate for this loss in revenue, a tax on electricity consumption by electric vehicles may be imposed. Taxes may be imposed by federal, state and local authorities. There may even be taxes imposed by cities, counties and special districts. Consequently, the aggregate tax rate must be determined for the location of every electric vehicle recharging outlet. The electricity vendor or utility company will pay the tax collected to the appropriate authority, which is likely to be a state tax equalization board. In turn, the state board sends the money to all the taxing authorities. As a collector of taxes, an electricity vendor or utility company will be subject to reporting requirements to the state board. The most likely measurement of electricity consumption for taxation purposes is the kilowatt-hour (kwh). Such a tax system will require accurate measurement and reporting of electricity consumed by electric vehicles. Furthermore, since the location of the electric vehicle when electricity is purchased determines the aggregate tax, ready determination of the recharging location is required. Consequently, there will be a need for a system for determination and collection of taxes and for reporting consumption information.

Another alternative to the gasoline tax is a road user fee—for example, as proposed by the State of Oregon. See Oregon Department of Transportation Final Report on Oregon's Mileage Fee Concept and Road User Fee Pilot Program, November 2007, available at http://www.oregon.gov/ODOT/HWY/RUFPP/docs/RUFPP_finalreport.pdf (last visited Jun. 4, 2008). A road user fee requires a convenient means of collection—the Oregon solution is to collect the fee through one or more of: uploading mileage fee data wirelessly through electric utility meters for billing on periodic electric bills; cellular uploads of mileage fee data to centralized data and billing centers; and upload mileage fee data and collect the fee at the time of vehicle re-registration. Consequently, under a road use tax scheme, there is a need for automated tax collection systems.

As is clear from the above discussion, communication networks are an essential part of electric vehicle recharging systems that will meet the needs of electric vehicle operators, recharging facility operators, utility companies and tax authorities. A survey of communication networks, ranging from local area networks to wide area networks, is provided below. There is a focus on wireless networks. A variety of communication devices are also described.

A radio frequency identification transmitter, commonly referred to as an RFID transmitter, is used for short range communication with an RFID receiver. Typical ranges are of the order of one meter to tens of meters. An example of an RFID transmitter is a remote keyless entry device.

A radio frequency identification transmitter, commonly referred to as an RFID transmitter, is used for short range communication with an RFID receiver. Typical ranges are of the order of one meter for communication with passive transmitters and hundreds of meters for communication with active transmitters. The longer range of the active transmitters is due to a power supply integrated into the transmitter. RFID transmitters store information which is broadcast over radio frequencies. An example of an RFID transmitter is a FasTrak® card, primarily used for payment of automotive tolls in California. Each FasTrak® card has a unique code which is associated with a debit account. Each time a FasTrak® card passes through a toll collection point, the unique code is transmitted by the card in response to being interrogated by an RFID transceiver. The code is detected by the RFID transceiver and the toll is debited from the user's account.

A wireless personal area network (WPAN) radio frequency transceiver is used for radio frequency short range (typically within 1-100 meters) communication between devices. An example of such a device is a Bluetooth® transceiver, where Bluetooth® refers to a particular standard and protocol primarily designed for short range radio frequency communications. Another example is a ZigBee® transceiver, where ZigBee® refers to a standard and protocol designed for short range radio frequency communications. ZigBee® transceivers form mesh networks.

A wireless local area network transceiver is used for radio frequency communication over tens of meters or more between devices. An example of such a device is a Wi-Fi® device, where a Wi-Fi® device is one that is based on the IEEE 802.11 standard. Another example is a ZigBee® device—see discussion above. Wireless local area networks (WLANs) are typically configured to provide higher throughput and cover greater distances than wireless personal area networks (WPANs); a WLAN typically requires more expensive hardware to set up than a WPAN.

Power line communication (PLC) technology can be used to network computers over electrical power lines. This technology is restricted to short distances for high-speed transmission of large amounts of data. An alternating current line transceiver is used to enable PLC. A PLC network is another example of a LAN.

Wired local area networks (wired LANS), which include both wire and optical fiber, are also used to connect computers. A wired LAN is distinguished from a PLC LAN by the use of dedicated wires, used only for carrying communication signals and not used as a power lines. The Ethernet is the most widespread wired LAN technology.

Wide area networks (WANs) are computer networks that cover a broad geographical area—a network that crosses city, regional or national boundaries. The best known example of a WAN is the Internet. The Internet is a worldwide, publicly accessible plurality of interconnected computer networks that use a standard protocol—Transmission Control Protocol (TCP)/Internet Protocol (IP). Many local area networks are part of the Internet. There are also privately owned WANs. The World Wide Web (WWW), often referred to as the Web, is a collection of interconnected web pages. The Web is accessible via the Internet.

There is a need to effectively integrate these wide area networks, local area networks and short range communication devices into systems used for recharging electric vehicles.

### SUMMARY OF THE INVENTION

A system for network-controlled charging of electric vehicles and the network-controlled electrical outlets used in this system are described herein. The system comprises electrical outlets, called Smartlets™, networked as follows: Smartlets™ and electric vehicle operators communicate via wireless communication links; Smartlets™ are connected by a LAN to a data control unit; and the data control unit is connected to a server via a WAN. The server stores: consumer profiles (including account information for payment); utility company power grid load data (updated in real time by the utility company); electricity consumption data that may be required for government tax purposes; and tax rate information received from tax authorities to allow an electric vehicle power consumption tax to be calculated. The system may be vehicle-to-grid enabled. The system of the invention may be used to assist in collecting a tax on electricity consumption by electric vehicles—the Smartlet™ system provides accurate measurement and reporting of electricity consumed by electric vehicles.

Vehicle operators may use a variety of mobile communication devices to communicate with the Smartlets™, including: one-way RFID, two-way RFID, WPAN and WLAN devices. Communication between the Smartlets™ and the data control unit may be either via a PLC LAN or a WLAN. The WAN may be a private WAN, or the Internet.

Some systems also include a payment station, remote from the Smartlets™, which can be set up to allow vehicle operators to pay for both parking and recharging of their vehicles. When payment stations are included in the system, the data control units may conveniently be incorporated into the payment stations. Some systems may be enhanced with a device for detecting the presence of a vehicle occupying the parking space in front of the Smartlet™. Such devices may include sonar, TV camera and induction coil devices. Furthermore, parking meter display units may be attached to the Smartlets™ to provide parking information, including: (1) paid parking time remaining; and (2) parking violation.

A Smartlet™ may comprise a network-controlled charge transfer device configured to connect to an electric vehicle for recharging; an electric power line connecting the charge transfer device to a local power source; a control device on the electric power line, for switching the charge transfer device on and off; a current measuring device on the electric power line, for measuring current flowing through the charge transfer device; a controller configured to operate the control device and to monitor the output from the current measuring device; a local area network transceiver connected to the controller, the local area network transceiver being configured to connect the controller to the data control unit; and a communication device connected to the controller, the communication device being configured to connect the controller to a mobile communication device, for communication between the operator of the electric vehicle and the controller.

A method of collecting electric vehicle power consumption tax for charge transferred between a local power source and an electric vehicle is disclosed herein. The method may comprise the following steps: (1) assembling a user profile, the user profile containing payment information, the user profile being stored on a server; (2) providing a network-controlled charge transfer device, the device being connected to the local power source by an electric power line, charge transfer along the electric power line being controlled by a controller configured to operate a control device on the electric power line, the controller being connected to a local area network for communication to the server via a wide area network; (3) requesting, by an operator of the electric vehicle, to the controller for charge transfer; (4) relaying the request from the controller to the server; (5) validating, by the server, a payment source for the operator of the electric vehicle based on the user profile corresponding to the operator; (6) determining by the server, from geographical tax rate data and the geographical location of the network-controlled charge transfer device, an applicable tax rate on the charge transfer; (7) enabling charge transfer by communicating from the server to the controller to activate the control device; (8) monitoring the charge transfer using a current measuring device on the electric power line, the controller being configured to monitor the output from the current measuring device and to maintain a running total of charge transferred; (9) detecting completion of the charge transfer; and (10) on detecting completion, processing payment with the payment source and disabling charge transfer; wherein the payment includes the electric vehicle power consumption tax.

The method of collecting electric vehicle power consumption tax may also include the step of including tax incentives and/or tax relief. For example, tax incentives may be available for using certain alternative electricity sources such as solar, wind, wave, tidal and hydroelectric. From the source of energy requested and tax incentive data provided by tax authorities, the server determines whether a tax incentive will apply. Tax relief may be available for vehicle operators who have a low income or provide a special service. From the tax status of the vehicle operator and tax relief data provided by tax authorities, the server determines whether tax relief will apply.

When a payment station is available to a vehicle operator, a request to the Smartlet™ controller for vehicle charging may be made from the payment station instead of by a mobile communication device. When a vehicle operator does not have a user profile on the server, then the request to the controller for charge transfer includes payment information.

### BRIEF DESCRIPTION OF THE FIGURES

FIG. 1 is a schematic diagram of a network-controlled charging outlet system according to a first embodiment of the invention.

FIG. 2 is a schematic diagram of a network-controlled charging outlet system according to a second embodiment of the invention.

FIG. 3 is a schematic circuit diagram of a network-controlled charging outlet of the invention.

FIG. 4 is a schematic circuit diagram of a parking meter display unit of the invention.

FIG. 5 is a schematic diagram of a server of the invention.

FIG. 6 is a schematic diagram of a remote payment system of the invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements.

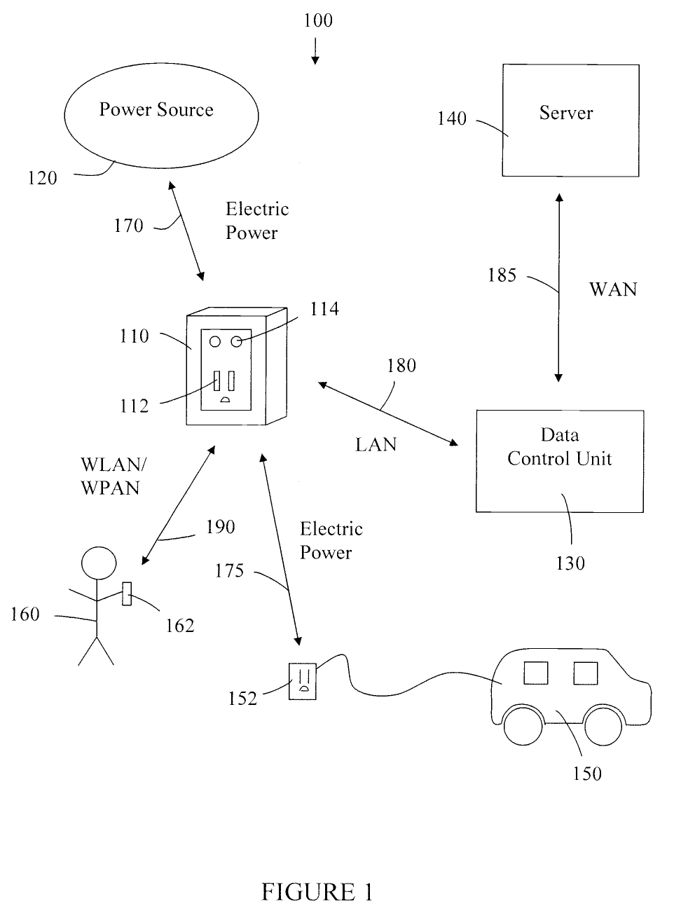

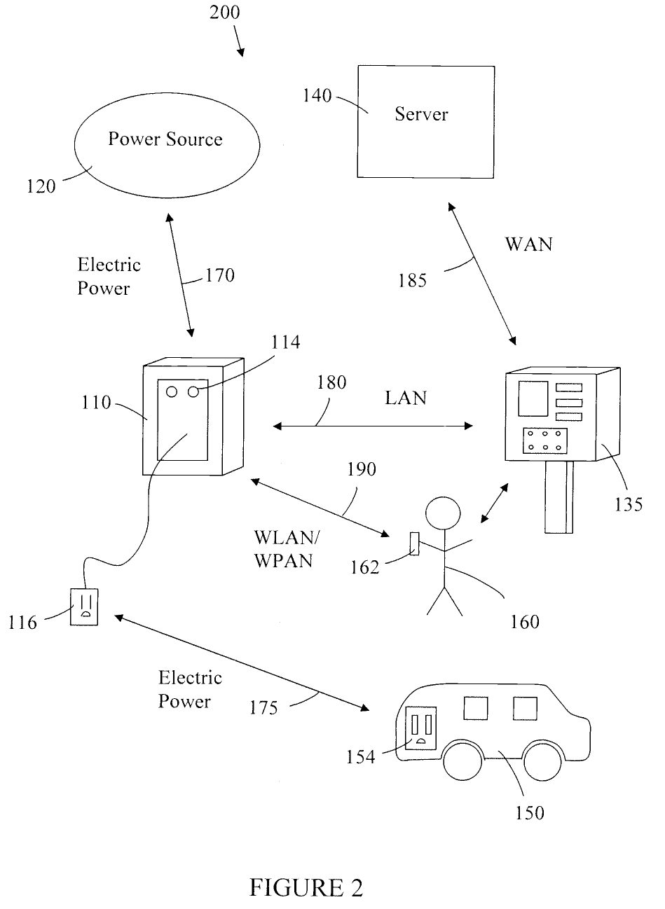

A first embodiment of the network-controlled charge transfer system 100 for charging electric vehicles is shown in FIG. 1. The system 100 comprises a network-controlled charge transfer device 110, a local power source 120, a data control unit 130, and a server 140. The system 100 interfaces with an electric vehicle 150, with an electrical connector 152, and an electric vehicle operator 160, via a mobile communication device 162. The network-controlled charge transfer device 110, referred to herein as a Smartlet™, is connected to the local power source 120 by an electric power line 170, and to the electric vehicle 150 by an electrical cable 175. As shown in FIG. 1, the electric vehicle 150 may be connected to the Smartlet™ 110 by an electrical connector 152 provided by the electric vehicle operator 160. Alternatively, as shown in FIG. 2, the electric vehicle may be connected to the Smartlet 110 by an electrical cable 116 which is hard wired into the Smartlet™ 110. The flow of electrical power may be in either direction for both of the electrical connections 170 and 175. In other words, the electric vehicle 150 can be recharged from the local power source 120, or the local power source 120 can receive power from the electric vehicle 150. The Smartlet™ 110 has a communication link to the data control unit 130 over a local area network (LAN) 180. The LAN 180 may be either a wireless local area network (WLAN) or a power line communication (PLC) network. The data control unit 130 has a communication link to the server 140 over a wide area network (WAN) 185. The electric vehicle operator 160 uses the mobile communication device 162 to establish a communication link to the Smartlet™ 110 over a wireless network 190. This wireless network may be a WLAN or a wireless personal area network (WPAN). The communication link between the electric vehicle operator 160 and the Smartlet™ 110 allows information to be shared which enables recharging of the electric vehicle 150.

The Smartlet™ 110 comprises an electrical receptacle 112 and indicator lights 114. Alternatively, the indicator lights 114 may be replaced with a display. The electrical receptor 112 and the electrical connector 152 are configured to make an electrical connection allowing safe flow of electrical power between the Smartlet™ 110 and the electrical vehicle 150. Examples of suitable receptacles are those conforming to the NEMA (National Electrical Manufacturers Association) standards 5-15, 5-20, 14-50 and SAE (Society of Automotive Engineers) standard J1772. Although, other receptacles will be used for systems outside the United States which operate at voltages other than 110V (for example 220V) and which are required to meet different standards. In preferred embodiments the electrical receptacle 112 has a cover. The cover is lockable and is released by the Smartlet™ 110 upon receipt of a request for charging of an electrical vehicle 150 by the electric vehicle operator 160. This request may be made by the mobile communication device 162, as described above.

The indicator lights 114 (or display) are used to show the operational status of the Smartlet™ 110—for example, the status may be: charging in progress, charging complete, vehicle-to-grid (V2G) in progress and error warning. The indicator lights 114 may be LEDs (light emitting diodes), may be capable of showing a number of different colors and may be capable of continuous or flashing modes of operation. Alternatively, the indicator lights 114 may be replaced by an alphanumeric display.

The local power source 120 may be an electrical supply grid owned and operated by local utility companies. Although, the local power source 120 may extend to parts of the electrical supply network that are not owned by the utility company, such as electrical cables on private premises and circuits which may be downstream from the utility company's meter. Alternatively, the local power source 120 may be an entirely privately owned circuit.

The data control unit 130 acts as a bridge between the LAN and the WAN, and enables communication between the Smartlet™ 110 and the server 140. The server 140 is generally remote from the Smartlet™ 110.

The system 100 is shown in FIG. 1 with only one Smartlet™ 110; however, the system will be comprised of many Smartlets™ 110, all linked to the server 140 through one or more data control units 130. There will be one data control unit 130 for each group of geographically proximate (within the range of the same local area network) Smartlets™ 110.

The electric vehicle 150 is any battery operated electric vehicle, including EVs and plug in hybrids. Electric vehicles 150 that have the necessary V2G electronics are able to provide power to the local power source 120.

The mobile communication device 162, used by the electric vehicle operator 160, can be any type of WLAN or WPAN compatible device, or a wired communication device. Examples of compatible devices are: one way and two-way RFID devices, an example of the latter being a FasTrac® card; RFID transmitters; Wi-Fi® devices, such as a computer; vehicle electronics; BlueTooth® devices, such as a mobile phone; and ZigBee®) devices. In some embodiments of the invention the vehicle user 160 can monitor charging using the mobile communication device 162. This can be implemented by allowing access by the vehicle user 160 to data recording the power consumed by the electric vehicle 150, which is monitored by the Smartlet™ 110 and stored on the server 140. Access can either be directly to the Smartlet™ 110 over a LAN or to the server 140 over the Internet.

A second embodiment of the network controlled charge transfer system 200 for charging electric vehicles 150 is shown in FIG. 2. The system 200 comprises a network-controlled charge transfer device (Smartlet™) 110, a local power source 120, a payment station 135, and a server 140. The system 200 may be interfaced with an electric vehicle 150, with an electrical cable 116, and an electric vehicle operator 160, via a mobile communication device 162. (In alternative embodiments, the electric vehicle may be connected to the system 200 by an electrical connector 152. See FIG. 1 for an example of such a connection.) The Smartlet™ 110 is connected to the local power source 120 by an electric power line 170, and to the electric vehicle 150 by the electrical cable 116. The electric vehicle 150 has a vehicle receptacle 154 for connecting with electrical cable 116. In some embodiments, an electric meter may be positioned between the Smartlet™ 110 and the power line 170. The flow of electrical power may be in either direction for both of the electrical connections 170 and 175. The Smartlet™ 110 has a communication link to the payment station 135 over a LAN 180. The LAN 180 may be either a WLAN or a PLC network. The payment station 135 has a communication link to the server 140 over a WAN 185. (In this embodiment, the payment station 135 includes a data control unit 130 for acting as a bridge between the LAN and the WAN.) The electric vehicle operator 160 may use the mobile communication device 162 to establish a communication link to the Smartlet™ 110 over a wired connection or wireless network 190. This wireless network may be a WLAN or a WPAN. Instead of using a mobile communication device 162, the electric vehicle operator 160 may manually interact with the payment station 135, which then sends appropriate instructions to the Smartlet™ 110 regarding charging of the electric vehicle 150.

The electrical cable 116 and vehicle receptacle 154 are configured to make an electrical connection allowing safe flow of electrical power between the Smartlet™ 110 and the electrical vehicle 150. Examples of suitable receptacles are those conforming to the NEMA (National Electrical Manufacturers Association) standards 5-15, 5-20, 14-50. Furthermore, examples of suitable receptacles and cables are those conforming to SAE (Society of Automotive Engineers) standard J1772. Although, other receptacles will be used for systems outside the United States which operate at voltages other than 110V (for example 220V) and which are required to meet different standards. The electrical cable 116 may be lockable to the Smartlet 110, and is released on instructions from the payment station 135, thus allowing the vehicle operator 160 to connect the electric vehicle 150 to the Smartlet™ 110 with the electrical cable 116.

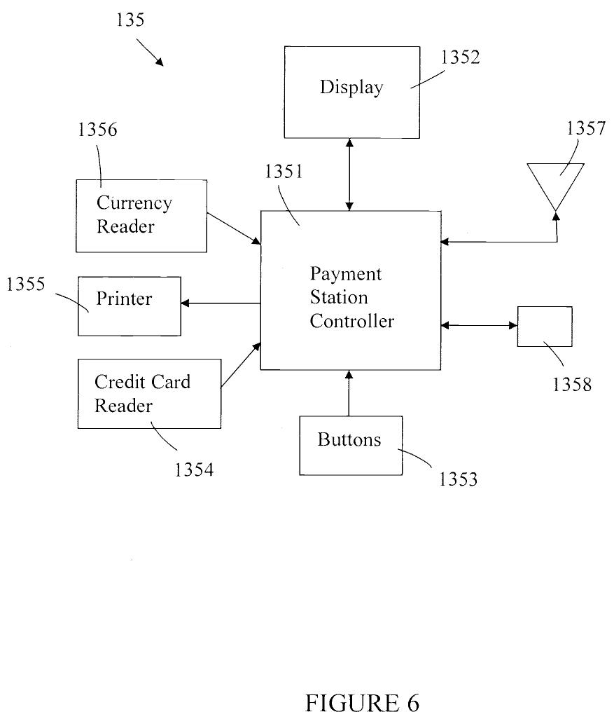

The payment station 135 can be several tens of meters remote from the Smartlet™ 110. The payment station 135 is shown comprising a currency reader, a credit card reader, a receipt printer, a display and input buttons. However, the payment station does not have to include all of these components. For example, some payment stations may not include a currency reader and will only allow payment by credit card using the credit card reader. The electric vehicle operator 160 can use the payment station 135 to pay for and schedule recharging of the electric vehicle 150, and also for V2G transactions. The payment station 135 may also be used to pay for parking. Further details of the payment station 135 are provided in FIG. 6 and the related description.

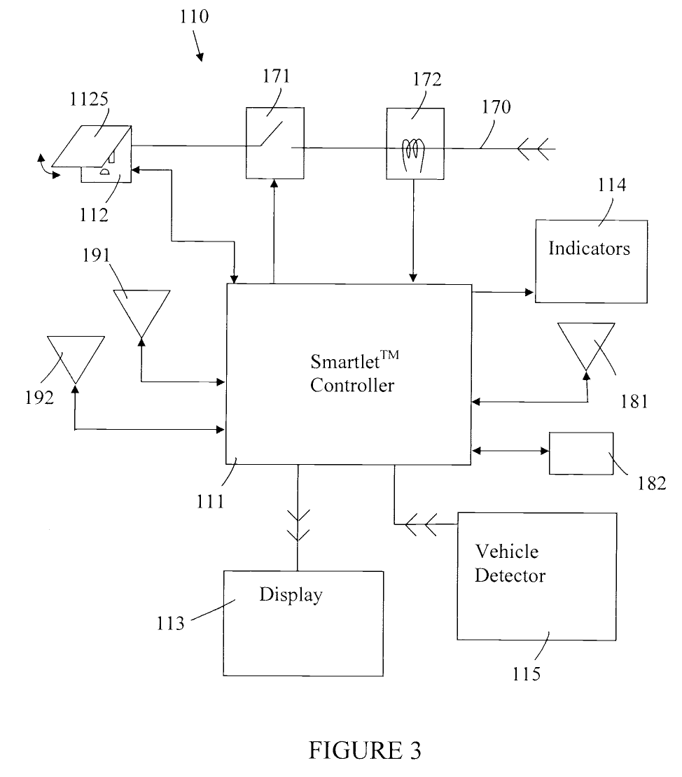

Smartlet™ 110 has several embodiments, including the embodiments shown in FIG. 1 and FIG. 2, with an electrical receptacle 112 and an electrical cable 116, respectively. A schematic of the Smartlet™ 110 with an electrical receptacle 112 is provided in FIG. 3. The Smartlet™ 110 comprises an electrical receptacle 112, a lockable cover 1125 over the electrical receptacle 112, a control device 171, a current measuring device 172, an electric power line 170, a controller 111, a display unit 113, a vehicle detector 115, a WLAN transceiver 181, an alternating current line transceiver 182, a WPAN transceiver 191 and an RFID transceiver 192.

Electric power is delivered to receptacle 112 along power line 170. Controller 111 is used to lock and unlock the cover 1125; the lock mechanism is electro-mechanical. When unlocked, the cover 1125 may be lifted by the vehicle operator 160 in order to connect the electric vehicle 150 to the electrical receptacle 112 using the electrical connector 152. Control device 171 is used to turn the electric supply at the receptacle 112 on and off. The control device 171 is preferably a solid state device and is controlled by controller 111. The current flowing along the power line 170 is measured by current measuring device 172. An example of a suitable measuring device 172 is an induction coil. The controller 111 is programmed to monitor the signal from the current measuring device 172 and to calculate the total energy (measured in kWh) either: consumed (in recharging the electric vehicle); or transferred to the local power source 120 from the electric vehicle 150 (V2G). It is also envisaged that energy may be both consumed and transferred to the grid during the time an electric vehicle is connected to the Smartlet™ 110, in which case the controller 111 will calculate both the energy consumed and the energy transferred to the local power source 120.

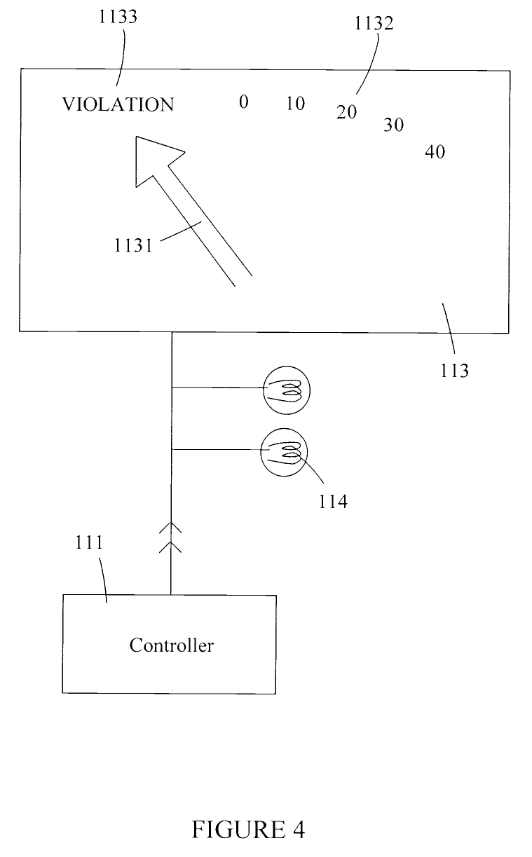

The indicators 114 and display 113 are controlled by the controller 111 and are used to provide information to the Smartlet™ 110 user. The indicators 114 are discussed in more detail above, with reference to FIG. 1, and the display 113 is discussed in more detail below with reference to FIG. 4.

Vehicle detector 115 is used to detect the presence of a vehicle in the parking space corresponding to the Smartlet™ 110. The vehicle detector 115 is controlled by the controller 111. The vehicle detector 115 is a detector such as a sonar sensor, a camera, or an induction coil. The sonar sensor is similar to those used on the rear bumper of automobiles to detect close proximity to an object; this sensor can be attached to the Smartlet™ 110 or will be mounted to a support structure in close proximity to the Smartlet™ 110. The camera is a digital camera providing a video signal to the Smartlet™ 110; the video signal is processed by an object recognition program to detect the presence of a vehicle or other obstruction. The induction coil is either embedded in the pavement of the parking space or is protected by a roadworthy casing attached to the surface of the pavement. The induction coil is connected to the Smartlet™ 110 and detects the presence of large metal objects in close proximity to the coil (such as an engine block, electric motor or rear differential of a vehicle).

The controller 111 is shown with four transceivers—a WLAN transceiver 181, an alternating current line transceiver 182, a WPAN transceiver 191 and an RFID transceiver 192. A transceiver is a device that can send or receive signals, allowing for one-way or two-way communication. The WLAN transceiver 181 allows for the controller to communicate with mobile communication devices which may be carried by a vehicle operator 160 (see communication link 190 in FIGS. 1& 2) and with a data control unit 130 or payment station 135 (see communication link 180 in FIGS. 1 & 2). WLAN transceiver 181 could be a Wi-Fi® transceiver. The alternating current line transceiver allows the controller to communicate on a PLC network with a control data unit 130 or payment station 135 (see communication link 180 in FIGS. 1 & 2). The WPAN transceiver 191 allows the controller 111 to communicate with mobile communication devices 162 which may be carried by the vehicle operator 160. WPAN transceiver 191 could be a BlueTooth® or ZigBee® transceiver. The RFID transceiver 192 allows the controller to communicate with a compatible RFID device carried by the vehicle operator 160. An example of an RFID device that could be carried by the vehicle operator 160 is a FasTrak® card. A FasTrak® device is an example of a two-way RFID communication device. Although, a one-way RFID communication device from vehicle operator 160 to controller 111 can be utilized, as can a wired communication device from the vehicle. Not all embodiments of the Smartlet™ 110 have all four types of transceiver; however, all Smartlets™ 110 will have at least one wireless transceiver for communication with compatible mobile communication devices 162 available to vehicle operators 160, and one transceiver for communication with the data control unit 130. See FIGS. 1 & 2.

The description of FIG. 3 provided above is also applicable to Smartlet™ 110 with an electrical cable 116 instead of an electrical receptacle 112, except that instead of having a lockable cover 1125 the Smartlet™ may have a locking device which fixes the cable 116 to the Smartlet™ when not in use.

A more detailed view of the display unit 113 is shown in FIG. 4. An example of parking information is shown on the display unit 113—an indicator 1131 shows the paid parking time remaining in minutes 1132 or a parking violation 1133. This parking information may be displayed in many other ways than that shown in FIG. 4. The display unit 113 may be an LCD (liquid crystal display); although other passive flat panel displays such as OLEDs (organic light emitting displays) and other emissive flat panel displays such as FEDs (field emission displays) may be used. When a passive display unit 113 is used it is preferred that it be backlit, so as to be readily viewed in low ambient light conditions. The display unit 113 is attached to the Smartlet™ 110 so that it is readily observable by the vehicle operator 160. For example, the display 113 may be mounted on a pole at a height of approximately 125 cm above the pavement, and the Smartlet™ 110 would also be mounted on the pole at a convenient height for the vehicle operator. The indicator lights 114 may be positioned next to the display 113, or may be positioned on the Smartlet™ 110 itself, as shown in FIGS. 1 & 2. The display 113 is controlled by the controller 111. The display 113 may also be used to display information regarding the vehicle charging process, such as: time charging, power consumed, estimated time to completion of charging, vehicle-to-grid (V2G) power transferred, general status indications and error warnings.

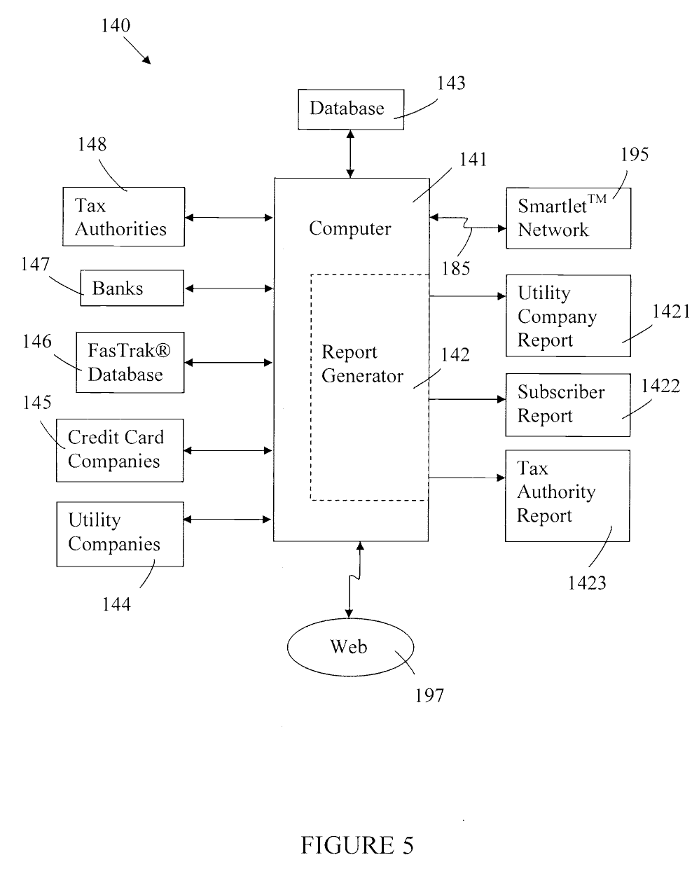

A schematic diagram of the server 140 is shown in FIG. 5. The server 140 comprises a computer 141, report generator 142, and database 143. The server 140 is configured to communicate with the following: Smartlet™ network 195; World Wide Web 197; utility companies 144, for receiving power load management data and sending payments for power consumed (less power sold back to the grid); credit card companies 145, for credit authorization and charging; FasTrak® database 146, for debiting FasTrak® accounts; banks 146, for debiting bank accounts; and tax authorities 148, for receiving tax rate information and sending tax payments. Here tax rate information may include both consumption and access taxes (the latter is also referred to as a privilege tax), as applicable. In addition to municipal, county, district, state and federal tax rates, information received from tax authorities 148 may include, details of tax incentive schemes to encourage use of electricity from sources such as wind and solar. The database 143 is used to store consumer profiles and other data required for report generation, as described below. The report generator 142 creates reports such as: utility company reports 1421, detailing power consumed and V2G power sold to the local power grid; subscriber reports 1422, detailing power consumed and V2G power sold to the local power grid, account balance, payments and invoices, and subscriber profile data; and tax authority reports 1423, providing details of taxable transactions, taxes collected, and taxes paid by the Smartlet™ operator to the tax authority. In general, the tax authority will be the applicable state equalization board. However, when the Smartlet™ operator is a city or municipality the city may directly take municipal taxes.

The Smartlet™ network 195 comprises a multiplicity of data control units 130 and/or payment stations 135, each data control unit 130 and/or payment station 135 being connected by a communication link 180 to a multiplicity of Smartlets™ 110. The communication link 185 between the computer 141 and the Smartlet™ network 195 is a WAN.

The server 140 is interfaced with the Web 197 to allow subscribers (owners and operators 160 of electric vehicles 150) to do the following: (1) set-up user/consumer profiles; and (2) determine availability of Smartlets™ 110 for recharging their electric vehicles 150. A user profile contains financial account information—details required for payment—and may also include information such as whether the vehicle operator wants to: charge the electric vehicle only during periods of lower power rates; not charge the vehicle during periods of high power grid load; sell power to the local grid; buy electricity generated by a particular means, such as wind, solar or hydroelectric; and exchange carbon offsets. The user profile may also contain information relevant to the calculation of tax due to taxing authorities. For example, the profile may contain information regarding: the subscriber's eligibility for tax incentives, reductions or exemptions, such as low-income tax exemptions; the subscriber's liability for taxes such as road use tax, including uploaded electric vehicle odometer readings; and subscriber identification for tax purposes, such as a vehicle identification number or a social security number.

The availability of Smartlets™ 110 for recharging a subscriber's vehicle is stored on the server and the information is collected from the Smartlet™ network 195. There are two ways that the availability of a Smartlet™ 110 can be determined: (1) using a vehicle detector 115 (see FIG. 3 and related description) to determine whether the parking space corresponding to the Smartlet™ 110 is available; and (2) flagging a Smartlet™ 110 as being unavailable whenever charging is ongoing, V2G is ongoing or parking has been paid for.

A schematic diagram of the payment station 135 is shown in FIG. 6. The payment station 135 comprises a controller 1351, a display 1352, a set of buttons 1352, a credit card reader 1354, a receipt printer 1355, a currency reader 1356, a wireless transceiver 1357 and an alternating current line transceiver 1358.

The display 1352 provides a vehicle operator 160 with information regarding recharging and/or parking their electric vehicle 150. The display shares the same characteristics as the display 113 discussed above with reference to FIG. 4. However, the display 1352 may also be touch sensitive, allowing a vehicle user to input information directly on the display screen 1352. The buttons 1353 allow for input of information requested from the display 1352.

The credit card reader 1354 is used for reading credit cards, debit cards, smart cards, and other cards that are used for identification purposes or for making payment. The printer 1355 is used for printing receipts, when requested by the consumer. The printer 1355 may also be used to print receipts for displaying in the electric vehicle 150 to show that recharging and/or parking is properly permitted. The currency reader 1356 is used for accepting currency—notes and/or coins—for payment. The currency reader 1356 is able to authenticate and identify the value of currency accepted.

The payment station 135 is networked to Smartlets™ 110 via either a WLAN or a PLC. The payment station controller 1351 may include a data control unit 130 which acts as a bridge between the LAN 180 and the WAN 185. See FIGS. 1 & 2.

A vehicle user 160 can use the network-controlled charge transfer systems 100 and 200 for charging their electric vehicle 150. A vehicle user 160 who has a user profile on the server 140 is referred to as a subscriber. Some examples of how the systems 100 and 200 can be used are provided below.

### Vehicle Charging Utilizing a Mobile Communication Device

1. a subscriber uses the Internet to establish a profile, which includes setting-up payment by credit card, debiting a bank account, a FasTrak® account, a PayPal® account, or other financial service;
2. the subscriber uses a communication device 162, such as an RFID transmitter, a mobile phone or a FasTrak® card, to request to the Smartlet™ 110 to charge the electric vehicle 150;
3. the subscriber connects the electric vehicle 150 to the Smartlet™ 110 using the connector 152 (see FIGS. 1 & 2);
4. the Smartlet™ 110 relays this request over the communication network to the server 140;
5. the server 140 accesses the subscriber profile from the database 143, validates the payment source by contacting the credit card company, FasTrak® database or bank, or confirms the balance available in a subscriber account on the system, and via the communication network enables the Smartlet™ 110 to charge the vehicle 150;
6. based on the subscriber profile and load management data from the utility company the server determines the charging periods and communicates this information to the Smartlet™ 110;
7. the Smartlet™ 110 monitors the charging current, as described above with reference to FIG. 3;
8. when the vehicle 150 is disconnected from the Smartlet™ 110, charging is disabled and a request for payment is sent to the payment source; when the payment source is the subscriber's account on the system, the cost of charging is deducted from the subscriber's account. (The preferred method of payment is for a subscriber to have an account on the system into which preauthorized lump sums are deposited—from a credit card, bank account, etc.) Note that determining when the electric vehicle 150 is disconnected from the Smartlet™ 110 can be done by: detecting when the current flow goes to zero; or using a sensor on the receptacle 112 which detects the mechanical removal of the connector 152. If a sensor is used, the sensor is monitored by controller 111. See FIG. 3.
   Note that the load management data from the utility company may limit the ability to recharge the vehicle 150 or the recharge rate for vehicle 150, according to a Demand Response system. For example, the utility company could send a message to the Smartlet™ server 140 requiring a reduction in load. The Smartlet™ server 140 then turns off charging of some vehicles 150. Which vehicles have charging stopped will depend on the subscriber profiles and the requirements of the Demand Response system. The Demand Response system and subscriber profiles may also allow for V2G.

The general procedure described above is also followed for V2G or a combination of charging and V2G, except that V2G will result in credits to the subscriber's account for sale of power to the local power grid.

### Vehicle Charging Utilizing a Payment Station

1. vehicle user 160 uses the payment station 135 to request and pay for charging the vehicle 150;
2. vehicle user 160 connects the electric vehicle 150 to the Smartlet™ 110 using connector 152 or cable 116;
3. the payment station 135 communicates via WAN 185 with server 140 for payment authorization;
4. the payment station 135 enables the Smartlet™ 110 for charging;
5. when the vehicle is disconnected from the Smartlet™ 110, charging is disabled, the payment station 135 is notified, the payment station 135 notifies the server 140 and a request for payment is sent to the payment source, and if the payment source is a subscriber account on the system, the amount is deducted from the subscriber's account.
   Note that the load management data from the utility company may limit the ability to recharge the vehicle 150 or the recharge rate for vehicle 150, according to a Demand Response system.

The general procedure described above is also followed for V2G or a combination of charging and V2G, except that V2G will result in credits to the vehicle users account for sale of power to the local power grid.

### Vehicle Parking Utilizing a Mobile Communication Device

1. a subscriber uses the Internet to establish a profile, which includes setting-up payment by credit card, debiting a bank account, a FasTrak® account, a PayPal® account, or other financial service;
2. the subscriber uses a mobile communication device 162, such as an RFID transmitter or a mobile phone, to request to the Smartlet™ 110 parking for the vehicle 150;
3. the Smartlet™ 110 relays this request over the communication network to the server 140;
4. the server 140 accesses the subscriber profile from the database 143, validates the payment source by checking the subscriber's account on the system, or by contacting the credit card company, FasTrak® database or bank, and via the communication network sends a message to the Smartlet™ 110 to allow parking of the vehicle 150;
5. the Smartlet™ 110 sets the parking meter shown on display 113 (see FIGS. 3 & 4) and sets the indicators 114, if used;
6. the server 140 sends a request for payment to the payment source; when the payment source is the subscriber's account on the system, the cost of charging is deducted from the subscriber's account.
   Optionally, if a vehicle detector 115 is used to detect the presence of a vehicle, then the amount of time a vehicle is parked without proper payment may be monitored and communicated to the payment station 135 and server 140.

### Vehicle Parking Utilizing a Payment Station

1. vehicle user 160 uses the payment station 135 to request and pay for parking the vehicle 150;
2. the payment station 135 communicates via WAN 185 with server 140 for payment authorization;
3. the payment station 135 communicates to the Smartlet™ 110 to allow parking;
4. the server 140 sends a request for payment to the payment source; when the payment source is a subscriber's account on the system, the cost of charging is deducted from the subscriber's account.

The above methods for use of the Smartlet™ network for electric vehicle charging, V2G and parking can be combined. For example, a parking fee may be imposed in addition to a fee for power consumed in recharging a vehicle. Also, a parking fee may be imposed when a vehicle is parked for V2G.

As discussed above, an electric vehicle consumption tax may be imposed by federal, state, district, county and/or municipal authorities. Should such a tax be imposed, then the network-controlled charge transfer systems 100 and 200 must be able to collect the tax. Some examples of how the systems 100 and 200 can be used to collect an electric vehicle power consumption tax are provided below. ps Determination of Applicable Tax Rate

Tax authorities provide geographical tax rate data, detailing the rates for specific states, districts, counties and municipalities. This information is stored on the server 140. The server also collects data regarding the geographical location of each electrical receptacle 110 and/or payment station 135. The location data may be permanently stored on the server 140, or may be provided when an electrical receptacle controller 111 or a payment station controller 1351 contacts the server 140 to request a charge transfer. From the geographical location of the electrical receptacle 110 or payment station 135 and the geographical tax rate data, an applicable tax rate can be calculated for any charge transfer. Applicable tax rates may either be calculated at the time a request for a charge transfer is received by the server 140, or be calculated in advance and stored on the server 140.

Furthermore, tax authorities may have tax incentives. For example, there may be tax incentives to encourage the use of alternative power sources, such as solar, wind, wave, tidal and hydroelectric. Generally these alternative power sources provide power to the power source 120 and consumers can pay a special (more expensive) price for power from these sources, subject to availability. Tax authorities provide such tax incentive data and it is stored on the server 140. The server also collects data regarding the source of energy the vehicle operator requests. The source of energy may be determined when an electrical receptacle controller 111 or a payment station controller 1351 contacts the server 140 to request a charge transfer. Alternatively, the source of energy may be stored in a vehicle operator's user profile. From the source of energy and the tax incentive data, the server 140 determines whether a tax incentive will apply. Thus, when an applicable tax rate is being determined by the server 140, as described above, tax incentives can be taken into account.

Yet further, tax authorities may provide tax relief to vehicle operators 160 who have a certain tax status. For example, vehicle operators 160 who have a low income or provide a special service may be eligible for tax relief. Tax authorities provide such tax relief data and it is stored on the server 140. The server also collects data regarding the tax status of the vehicle operator. The tax status may be determined when an electrical receptacle controller 111 or a payment station controller 1351 contacts the server 140 to request a charge transfer. Alternatively, the tax status may be stored in a vehicle operator's user profile. From the tax status and the tax relief data, the server determines whether tax relief will apply. Thus, when an applicable tax rate is being determined by the server 140, as described above, tax relief can be taken into account.

### General Procedure for Tax Collection

The total charge transferred to the electric vehicle 150 is measured as described above. The measurement of total charge (in kWh) is sent to the server 140. The server 140 calculates the appropriate tax from the applicable tax rate and the measurement of total charge. The tax is included in the amount that is submitted in the request for payment to the payment source. The tax received from payment sources is then transferred to the appropriate tax authority (generally the state equalization board) on a periodic basis (typically monthly or quarterly).

### Tax Collection for Subscribers

A subscriber's profile, stored on the server 140, will contain payment information—identifying a pre-approved payment source. The profile may also contain information relevant to calculating the consumption tax due on a charge transfer to the subscribers electric vehicle 150. For example, the profile may: specify a preference for a particular source of energy which may entitle the subscriber to a tax incentive; specify a tax status which may entitle the subscriber to tax relief; and/or include tax identification for the subscriber.

Furthermore, a subscriber's profile may contain instructions to exchange carbon offsets when applicable.

### Tax Collection for Non-Subscribers

Non-subscribers do not have a profile stored on the server. Consequently, a payment source must be identified and pre-approved prior to beginning charge transfer to an electric vehicle 150. Furthermore, for a non-subscriber to purchase energy from a particular source, to take advantage of tax incentives and/or tax relief, or to exchange carbon offsets may require a set of interrogatories, most conveniently placed in a user friendly graphical user interface.

### Reporting to Tax Authorities

Whenever a charge transfer to an electric vehicle is subject to a consumption tax, the following information is stored on the server 140: a record of the total amount of charge (measured in kWh) transferred; the amount of tax collected; and the geographical location of the transaction (location of the electrical receptacle 110 or payment station 135). This information is available to the report generator 142 on the server 140 for generating reports for tax authorities.

The above embodiments of the present invention have been given as examples, illustrative of the principles of the present invention. Variations of the apparatus and method will be apparent to those skilled in the art upon reading the present disclosure. These variations are to be included in the spirit of the present invention. For example, the Smartlet™ network may be used for public and private garage and parking lot charging of electric vehicles. Furthermore, the Smartlet™ network may be used for home charging of electric vehicles, in which case a Smartlet™ receptacle in the home is connected via a LAN and a WAN to the Smartlet™ server 140. Those skilled in the art will appreciate that the Smartlet™ network may also be used for non-vehicle applications, including selling electricity to people in places such as airports and coffee shops.

What is claimed is:

1. A method of collecting electric vehicle power consumption tax for charge transferred between a local power source and an electric vehicle, comprising:
assembling a user profile, said user profile containing payment information, said user profile being stored on a server;
providing a network-controlled charge transfer device, said device being connected to said local power source by an electric power line, charge transfer along said electric power line being controlled by a controller configured to operate a control device on said electric power line, said controller being connected to a network for communication to said server;
requesting, by an operator of said electric vehicle, to said controller for charge transfer;
relaying said request from said controller to said server;
validating, by said server, a payment source for said operator of said electric vehicle based on said user profile corresponding to said operator;
determining by said server, from geographical tax rate data and the geographical location of said network-controlled charge transfer device, an applicable tax rate on said charge transfer;
enabling charge transfer by communicating from said server to said controller to activate said control device;
monitoring said charge transfer using a current measuring device on said electric power line, said controller being configured to monitor the output from said current measuring device and to maintain a running total of charge transferred;
detecting completion of said charge transfer; and
on detecting completion, processing payment with said payment source and disabling charge transfer;
wherein said payment includes said electric vehicle power consumption tax.

2. A method as in claim 1, further comprising recording on said server the total charge transferred to said electric vehicle.

3. A method as in claim 2, further comprising:
generating a report of power consumed for tax authorities;
wherein the record of said total charge transferred is available for generating said report.

4. A method as in claim 1, further comprising storing on said server data identifying the geographical location of said network-controlled charge transfer device.

5. A method as in claim 1, further comprising sending, by said controller to said server, data identifying the geographical location of said network-controlled charge transfer device.

6. A method as in claim 1, further comprising receiving, at said server, geographical tax rate data from tax authorities.

7. A method as in claim 1, further comprising storing, in said user profile, a preference for a source of energy.

8. A method as in claim 7, wherein said source of energy is selected from the group consisting of solar, wind, wave, tidal and hydroelectric.

9. A method as in claim 7, further comprising receiving, at said server, tax incentive data from tax authorities.

10. A method as in claim 9, further comprising determining by said server, from said tax incentive data and said source of energy, whether a tax incentive applies to said charge transfer.

11. A method as in claim 1, further comprising storing, in said user profile, a tax status, said tax status indicating eligibility for tax relief.

12. A method as in claim 11, further comprising receiving, at said server, tax relief data from tax authorities.

13. A method as in claim 12, further comprising determining by said server, from said tax relief data and said tax status, whether tax relief applies to said charge transfer.

14. A method as in claim 1, further comprising storing, in said user profile, an instruction to exchange carbon offsets.

15. A method as in claim 1, wherein said vehicle operator uses a mobile communication device to request to said controller for charge transfer.

16. A method as in claim 1, wherein said wide area network is the Internet.

17. A method as in claim 1, wherein said user profile is assembled from information provided by a vehicle operator over the Internet.

18. A method of collecting electric vehicle power consumption tax for charge transferred between a local power source and an electric vehicle, comprising:
assembling a user profile, said user profile containing payment information, said user profile being stored on a server;
providing a network-controlled charge transfer device, said device being connected to said local power source by an electric power line, charge transfer along said electric power line being controlled by a controller configured to operate a control device on said electric power line;
receiving a request to a remote payment station for charge transfer, said request being made by an operator of said electric vehicle, said remote payment station being connected to an alternating current line transceiver, said alternating current line transceiver being configured to connect said remote payment station to a power line communication network for access to said controller;
relaying said request from said remote payment station to said server, said remote payment station comprising a data control unit for communication to said server via a wide area network;
validating a payment source for said operator of said electric vehicle based on said user profile corresponding to said operator;
determining by said server, from geographical tax rate data and the geographical location of said remote payment station, an applicable tax rate on said charge transfer;
communicating successful validation of payment from said server to said remote payment station;
enabling charge transfer by communicating from said remote payment station to said controller to activate said control device;
monitoring said charge transfer using a current measuring device on said electric power line, said controller being configured to monitor the output from said current measuring device and to maintain a running total of charge transferred;
detecting completion of said charge transfer; and
on detecting completion, processing payment with said payment source and disabling charge transfer;
wherein said payment includes said electric vehicle power consumption tax.

19. A method as in claim 18, further comprising storing, on said server, data identifying the geographical location of said remote payment station.

20. A method as in claim 18, further comprising sending, by said remote payment station to said server, data identifying the geographical location of said remote payment station.

21. A method as in claim 18, further comprising receiving at said server geographical tax rate data from tax authorities.

22. A method of collecting electric vehicle power consumption tax for charge transferred between a local power source and an electric vehicle, comprising:
providing a network-controlled charge transfer device, said device being connected to said local power source by an electric power line, charge transfer along said electric power line being controlled by a controller configured to operate a control device on said electric power line, said controller being connected to a network for communication to a server;
requesting, by an operator of said electric vehicle, to said controller for charge transfer, said request including payment information;
relaying said request from said controller to said server;
validating, by said server, a payment source for said operator of said electric vehicle based on said payment information;
determining by said server, from geographical tax rate data and the geographical location of said network-controlled charge transfer device, an applicable tax rate on said charge transfer;
enabling charge transfer by communicating from said server to said controller to activate said control device;
monitoring said charge transfer using a current measuring device on said electric power line, said controller being configured to monitor the output from said current measuring device and to maintain a running total of charge transferred;
detecting completion of said charge transfer; and
on detecting completion, processing payment with said payment source and disabling charge transfer;
wherein said payment includes said electric vehicle power consumption tax.

23. A method as in claim 22, further comprising storing on said server data identifying the geographical location of said electrical receptacle.

24. A method as in claim 22, further comprising sending by said controller to said server, data identifying the geographical location of said network-controlled charge transfer device.
